(19) United States
(12) Patent Application Publication
(10) Pub. No.: US 2026/0228329 A1
(43) Pub. Date: Aug. 6, 2026

(54) SYSTEM AND METHOD OF APPLICATION PROGRAMMING INTERFACE (API) ANOMALY DETECTION

(71) Applicant: ARIEL SCIENTIFIC INNOVATIONS LTD., Ariel (IL)

(72) Inventors: Ran DUBIN, Ariel (IL); Amit DVIR, Ariel (IL); Udi AHARON, Ariel (IL)

(21) Appl. No.: 19/149,938

(22) PCT Filed: Jan. 22, 2024
(86) PCT No.: PCT/IL2024/050089

§ 371 Date: Jul. 22, 2025

(30) Foreign Application Priority Data
Jan. 22, 2023 (IL) 300083

(51) Int. Cl. G06F 21/55; G06F 9/445

(52) U.S. Cl. CPC G06F 21/552; G06F 9/44589

(57) ABSTRACT

A system and method of Application Programming Interface (API) anomaly by a processor may include receiving a target API request; inferring a machine-learning based language model on the target API request, to generate a target API vector, representing an embedding of a text of the target API request in a textual embedding space; obtaining a nearest neighbor model, comprising a plurality of baseline API vectors, each representing embedding of text of a respective baseline API request in the textual embedding space; searching the nearest neighbor model, based on the target API vector, to select one or more baseline API vectors; calculating a similarity metric value, representing similarity of the target API request to the one or more baseline API requests, based on the target API vector and the selected one or more baseline API vectors; and determining anomaly of the target API request, based on the similarity metric value.

### CROSS-REFERENCE TO RELATED APPLICATIONS

This application is a PCT International Application, claiming the benefit of Israeli Patent Application No. 300083, filed Jan. 22, 2023, and entitled “SYSTEM AND METHOD OF APPLICATION PROGRAMMING INTERFACE (API) ANOMALY DETECTION”, hereby incorporated by reference in its entirety.

### FIELD OF THE INVENTION

The present invention relates generally to cyber security. More specifically, the present invention relates to systems and methods of Application Programming Interface (API) anomaly detection.

### BACKGROUND OF THE INVENTION

Detection of Application Programming Interface (API) cyber-attacks is a complex task, typically implemented by methods of Artificial intelligence (AI), aiming at identification of patterns for exploiting vulnerabilities. Applying supervised AI learning in such conditions is typically ineffective, due to the rareness, and diverse nature of attacks.

Another approach may include use of signatures, that may be effective for known attacks, but those are commonly overcome as new types of cyber-attacks are frequently discovered.

### SUMMARY OF THE INVENTION

Embodiments of the invention may include a generic cyber-security, AI or Machine-learning (ML)-based engine that is easily scalable, to match the ever-changing formats of API cyber-attacks, and provide zero-shot (i.e., without reference), semi-supervised attack detection and mitigation.

Embodiments of the invention may include a method of API anomaly detection by at least one processor.

According to some embodiments, the at least one processor may receive a target API request from at least one client computing device; infer a machine-learning (ML) based language model on the target API request, to generate a target API vector, representing an embedding of a text of the target API request in a textual embedding space.

The at least one processor may obtain, or train a nearest neighbor model, that may include a plurality of baseline API vectors, each representing embedding of text of a respective baseline API request in the textual embedding space, and may search the nearest neighbor model, based on the target API vector, to select one or more baseline API vectors.

The at least one processor may calculate a similarity metric value, representing similarity of the target API request to the one or more baseline API requests, based on the target API vector and the selected one or more baseline API vectors, and determine anomaly of the target API request, based on the similarity metric value.

Additionally, or alternatively, the at least one processor may calculate one or more distance metric values, each representing a distance of the target API vector to a specific baseline API vector in the textual embedding space, and selecting the one or more baseline API vectors based on the one or more calculated distance metric values.

According to some embodiments, the at least one processor may obtain the nearest neighbor model by receiving a plurality of baseline API requests; inferring the ML based language model on the plurality of baseline API requests, to produce a respective plurality of baseline API vectors; and for one or more first baseline API vectors of the plurality of baseline API vectors, calculating respective baseline indices, where each baseline index represents neighborhood relationships (e.g., proximity) of a first baseline API vector with one or more second baseline API vectors, in the textual embedding space.

According to some embodiments, each baseline API request may be associated with endpoint information representing a type and/or origin of the baseline API request. Additionally, each baseline index may represent, or may include a compressed version of (i) the endpoint information of the respective baseline API request, and (ii) the baseline API vector of the respective baseline API request.

According to some embodiments, the target API request may be associated with endpoint information representing a type and/or origin of the target API request. In such embodiments, the at least one processor may use the baseline indices to perform an indexed search through the nearest neighbor model, thereby selecting one or more baseline API vectors. Each of the selected baseline API vectors may be characterized by: (i) having minimal distance from the target API vector in the textual embedding space, and (ii) having the same endpoint information as the target API request.

According to some embodiments, the endpoint information may include a combination of a method of the API request, a hostname associated with the API request, and a path included in the API request.

Additionally, or alternatively, the at least one processor may receive a dataset that includes a plurality of baseline API requests, each associated with corresponding endpoint information. For one or more baseline API requests of the dataset, the at least one processor may produce a respective, abstracted version, that may be fully textual, as elaborated in the examples provided herein. As elaborated herein, the at least one processor may apply an unsupervised training algorithm on the ML-based language model to produce the baseline API vectors based on: (a) the abstracted version of the baseline API requests, and (b) the endpoint information of the baseline API requests.

As elaborated herein, the textual embedding space may represent a reduced dimensionality of text in relation to the abstracted version of the baseline API requests of the dataset. Additionally, the baseline API vectors may include a substantially reproducible version of the at least one respective baseline API requests, in the textual embedding space.

According to some embodiments, the at least one processor may calculate, for one or more baseline API requests, one or more corresponding behavioural statistic values. The behavioural statistic values may represent a statistic metric of usage of baseline API requests associated with identical or similar endpoint information. The at least one processor may determine anomaly of the target API request further based on (i) the one or more behavioural statistic values and (ii) the endpoint information of the target API request.

Additionally, or alternatively, the at least one processor may restrict the at least one client computing device from accessing at least one application server computing device or storage server computing device, based on the determination of anomaly.

Additionally, or alternatively, the target API request may include a request to access a server computing device. In such embodiments, the at least one processor may transmit the target API request to the server computing device; receive, from the server computing device an API response corresponding to said target API request; and transmit the API response to the at least one client computing device based on the determination of anomaly.

Additionally, or alternatively, the at least one processor may analyze the API response to identify at least one token of personal information therein. The at least one processor may subsequently transmit, or block (e.g., refrain from transmitting) the API response to the at least one client computing device based, at least in part, on the identified token of personal information.

Embodiments of the invention may include a system for API anomaly detection. Embodiments of the system may include a non-transitory memory device, wherein modules of instruction code are stored, and at least one processor associated with the memory device, and configured to execute the modules of instruction code. Upon execution of said modules of instruction code, the at least one processor may be configured to receive a target API request from at least one client computing device; infer, or apply an ML based language model on the target API request, to generate a target API vector, representing an embedding of a text of the target API request in a textual embedding space. Additionally, the at least one processor may obtain a nearest neighbor model that includes a plurality of baseline API vectors, each representing embedding of text of a respective baseline API request in the textual embedding space, and search the nearest neighbor model, based on the target API vector, to select one or more baseline API vectors. The at least one processor may subsequently calculate a similarity metric value, representing similarity of the target API request to the one or more baseline API requests, based on the target API vector and the selected one or more baseline API vectors, and determine anomaly of the target API request, based on the similarity metric value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device which may be included in a system for API anomaly detection, according to some embodiments of the invention;

FIG. 2 is a block diagram depicting an overview of a system for API anomaly detection, according to some embodiments of the invention;

FIG. 3 is a block diagram depicting an API anomaly detection module, which may be included in a system for API anomaly detection, according to some embodiments of the invention;

FIG. 4 depicts an example of a Hypertext Transfer Protocol (HTTP) API request;

FIG. 5 is a table depicting an example of a conversion scheme, facilitating conversion of an API requests to a filtered, abstracted API request version, according to some embodiments of the invention;

FIG. 6 is a block diagram depicting an API response module, which may be included in a system for API anomaly detection, according to some embodiments of the invention; and

FIG. 7 is a flow diagram depicting a method of API anomaly detection by at least one processor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

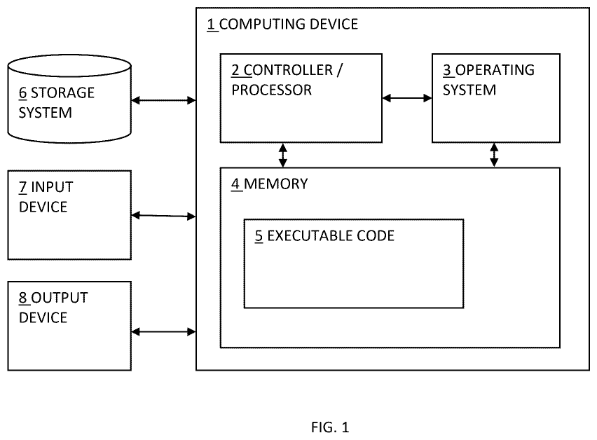

Reference is now made to FIG. 1, which is a block diagram depicting a computing device, which may be included within an embodiment of a system for API anomaly detection, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may detect anomalies in API traffic as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to API traffic may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

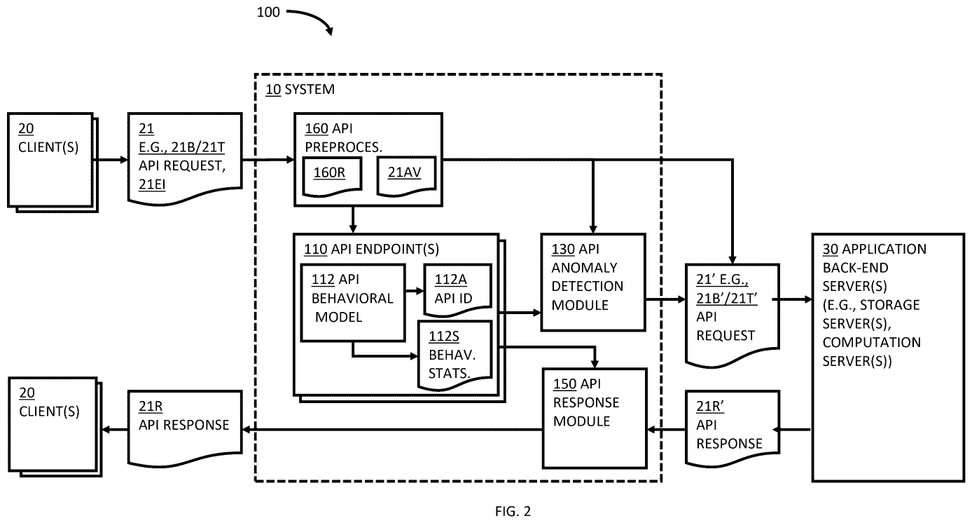

Reference is now made to FIG. 2, which is a block diagram, depicting a system 10 for API anomaly detection, according to some embodiments of the invention.

According to some embodiments of the invention, system 10 may be implemented as a software module, a hardware module, or any combination thereof. For example, system may be or may include a computing device such as element 1 of FIG. 1, and may be adapted to execute one or more modules of executable code (e.g., element 5 of FIG. 1) to detect or identify API traffic anomalies, as further described herein.

According to some embodiments, system 10 may be implemented by a single computing device 1, which may accommodate, or include all software and/or hardware components and modules of system 10.

Additionally, or alternatively, system 10 may be implemented by a distributed computing system (e.g., a cloud-based computing system), that may include a plurality of interconnected computing devices 1, each configured to implement a specific portion of the functions elaborated herein.

As shown in FIG. 2, arrows may represent flow of one or more data elements to and from system 10 and/or among modules or elements of system 10. Some arrows have been omitted in FIG. 2 for the purpose of clarity.

According to some embodiments, system 10 may be implemented as communicatively connected to one or more server computing devices.

As elaborated herein, system 10 may perform identification of API anomalies in two phases, or stages, referred to herein as a training, or preparation stage, and an application, or inference stage.

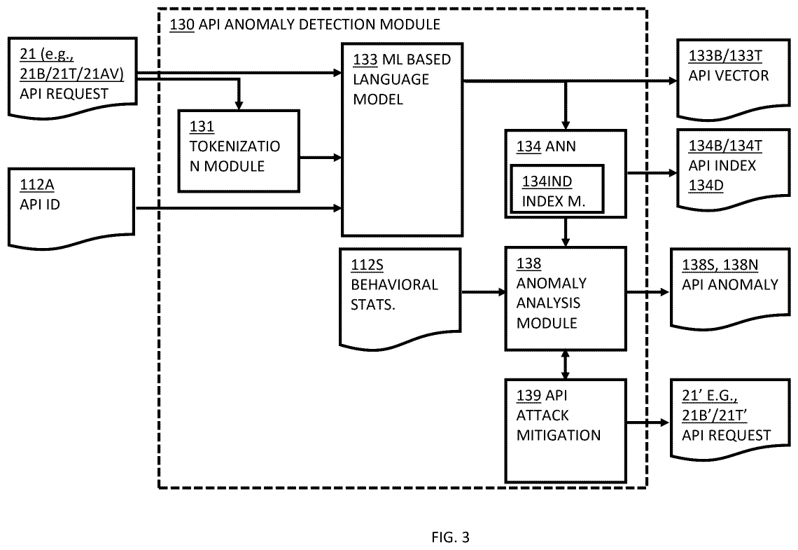

Reference is also made to FIG. 3, which is a block diagram, depicting an anomaly module 130, which may be the same as anomaly module 130 of FIG. 2, and may be included in a system 10 for API anomaly detection, according to some embodiments of the invention.

As elaborated herein, during a preparation or training stage, system 10 may receive, from a computing device (e.g., a client device 20 such as computing device 1 of FIG. 1), via a computer network 100 (e.g., the Internet) a plurality of API requests 21, that may be referred to as baseline API requests 21B.

The term “baseline” may be used in this context to indicate API requests that were received by system 10 prior to inference, e.g., prior to evaluating anomaly of an API request 21 of interest. It may be appreciated that over time, as system 10 receives, and clears additional API requests 21 of interest (e.g., also referred to herein as “target” API requests 21T), such API requests 21 may be added to the cohort of baseline API requests 21B, to refine the process of API anomaly detection by anomaly module 130.

During the training stage, system 10 may prepare or train one or more first models, such as a machine-learning (ML) based language model 133 to represent baseline API requests 21B as API vectors 133B in a textual embedding space.

As known in the art, the term “embedding space” may be used herein to refer to a representation of an original space of inputs, in a reduced dimension. For example, a “word embedding space” or a “textual embedding space” may refer to a vector space that represents originally input text, where samples of text bearing similar semantic meaning or context may reside in proximate locations.

Additionally, system 10 may prepare or train one or more second models, such as a nearest neighbour or Approximate Nearest Neighbour (ANN) model 134, to represent API vectors 133B of baseline API requests 21B by corresponding indices, referred to herein as baseline API indices 134B.

As elaborated herein, during the application, or inference stage, system 10 may receive, from a computing device 20 (e.g., a client device 20), an API request 21 of interest, that may be referred to as a target API request 21T. Target API request 21T may, or may not be identical to one or more baseline API requests 21B. System 10 may analyze target API request 21T in view of the prepared or trained models (e.g., 133, 134) to ascertain whether target API request 21T is anomalous.

It may be appreciated that the preparation (training) stage and application (inference) stage may be sequential, e.g., where the preparation stage precedes the application stage. Additionally, or alternatively, these stages may be concurrent, where actions of data preparation in models 133/134 may be performed substantially at the same time with identification of anomalous target API requests 21T.

Additionally, or alternatively, these stages may occur intermittently, cyclically, or repeatedly over time. For example, preparation of models 133/134 may be succeeded by evaluation of anomaly of an incoming target API request 21T, which may be succeeded by additional data model 133/134 preparation (e.g., introducing data of the new target API request 21T as a new baseline API request 21B in models 133/134), and so forth.

It may also be appreciated that the training stage may be the same for some (e.g., all) of models 133 and 134. Additionally, or alternatively, training of some (e.g., all) of models 133 and 134 may be performed separately, e.g., sequentially over time. Other such combinations may also be possible.

According to some embodiments, system 10 may be, may include, or may be associated with a gateway, a router or switch of a computer network 100, such as an organizational computer network 100, that may be defined by a specific network domain or location. Additionally, or alternatively, system 10 may be associated with, or integrated into one or more virtual components, such as a cloud-based server adapted to provide an online service via API requests 21T. Additionally, or alternatively, system 10 may be associated with, or integrated into a cluster or network of computing devices, such as the currently available Kubernetes cluster, which may be adapted to containerize application packages, and provide online services via API requests 21T.

As shown in FIG. 2, system 10 may include an API preprocessing module 160, adapted to capture raw API 21 traffic over network 100, e.g., between one or more client devices 20 and corresponding server devices 30. API preprocessing module 160 may process API requests 21, to produce a filtered, abstracted version 21AV of API requests 21, for further analysis.

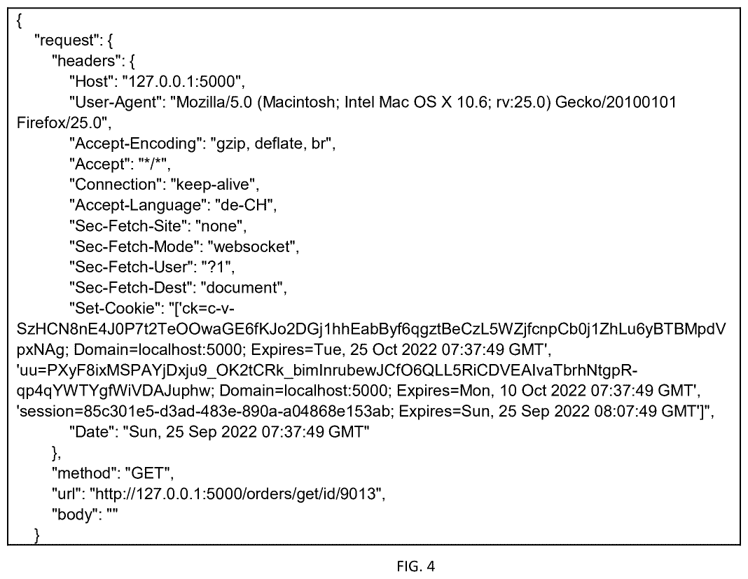

Reference is also made to FIG. 4, which depicts an example of an HTTP API request.

It may be appreciated that the term “API” may relate to any type of application-specific traffic that may be conveyed via network 100, including for example REST API requests and responses, HTTP requests and responses, Operating System (OS) APIs, Hardware APIs, Database (DB) APIs, and the like.

For example, as depicted in the HTTP API request example of FIG. 4, API request 21 may be divided into a header portion and a body portion, where each may include various types and formats (e.g., textual, symbolic and/or numerical formats) of data.

As known in the art, API request 21 headers typically provide information about the API request's 21 context, supply authentication credentials, and provide information about the client (e.g., a person, a computing device and/or a browser application) that had initiated the API request 21.

API request 21 header fields are typically derived from limited set of options. Accordingly, API preprocessing module 160 may use a predefined set of rules to verify API request 21 headers' content, and filter-out API request 21 according to these rules.

For example, API request 21 headers may include user-agent strings that contains information about the type, version and/or identification of operating systems and/or browsers that are being used by client 20.

Pertaining to the example of FIG. 4, fields of a User-Agent string may include: “Mozilla/5.0”, “(Macintosh; Intel Mac OS X 10.6; rv: 25.0)”, “Gecko/20100101”, and “Firefox/25.0”. API preprocessing module 160 may filter-out API requests 21 according to their specific headers: For example, API requests 21 that include valid, or approved user-agent strings may be transferred to their destination as API request 21′ and may be excluded from additional processing (e.g., by anomaly detection module 130, as elaborated herein).

In another example, API request 21 headers may include set-cookie strings, which are responsible for sending cookies from a server 30 to the user's agent or client 20.

Set cookie strings may include one or more attributes and corresponding value formats, such as Expires=<date>, Max-Age=<number>, Domain=<domain-value>, Path=<path-value>, Secure, HttpOnly, SameSite=Strict, SameSite=Lax, SameSite=None, and Secure. Pertaining to the example of FIG. 4, fields of the set cookie string include, for example: ck=“c-v SzHCN8nE4J0P7t2TeOOwa . . . ”, UU=“PXyF8ixMSPAYjDxju9_OK2tC . . . ”, Session=“85c301e5-d3ad-483e-0 . . . ”, etc., alongside corresponding domain and expiration fields.

In another example, API request 21 headers may include host strings, which specify host or Internet Protocol (IP) addresses and/or port numbers of a server 30 to which the API request is being sent. Valid IPV4 syntax of host strings (Host: <host>: <port>) should be in the format of: {0<=Num<256}. {0<=Num<256}. {0<=Num<256}. {0<=Num<256}: {1<=Num<=65535}. Pertaining to the example of FIG. 4, the fields of the Host string are: “127.0.0.1:5000”.

Additionally, or alternatively, API preprocessing module 160 may receive one or more predetermined rules 160R, defining content of legitimate headers. In this example, rules 160R may include definition of legitimate, or illegitimate header field such as set-cookie strings fields, host fields, Internet Protocol (IP) addresses, port numbers, and the like. API preprocessing module 160 may subsequently filter-out (e.g., block) API requests 21 that do not comply with these rules.

Additionally, or alternatively, API preprocessing module 160 may convert received, filtered API requests 21, to produce an abstracted version 21AV of these filtered API requests 21.

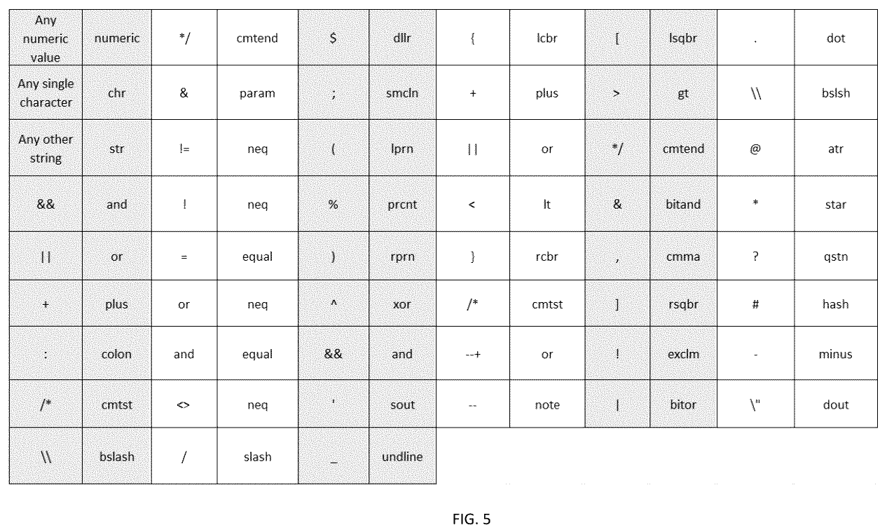

Reference is also made to FIG. 5, which is a table depicting an example of a conversion scheme, facilitating conversion of filtered API requests 21, to filtered, abstracted API request versions 21AV (or API requests 21AV, for short).

The term “abstracted” may be used herein to indicate that API request versions 21AV may represent an abstraction (e.g., a lossy abstraction) of original API requests 21. For example, as shown by pairs of columns in the example of FIG. 5, API preprocessing module 160 may convert each string in API request 21 to the string “str”, which is a representative, abstract version of the original string in API request 21.

Additionally, or alternatively, abstracted API request versions 21AV may be, or may include fully textual representations of API requests 21, and may thereby also be referred to as “fully textual” versions 21AV.

For example, as shown by pairs of columns in the example of FIG. 5, API preprocessing module 160 may convert each non-textual symbol in API request 21 to one or more predefined textual symbols or strings, to form abstracted API requests 21AV as fully textual vectors. For example, numerical values in API requests 21 may be converted to the string “numeric” in abstracted API requests 21AV. In another example, colon (“:”) symbols in API requests 21 may be converted to the string “colon” in API requests 21AV, etc. Other such textual representations of symbols in API request 21 may also be possible.

Pertaining to the example of FIG. 4, API preprocessing module 160 may convert an HTTP API request string 21 such as “/orders/get/id/9013 gzip, deflate, br de-CH none websocket?1 document” in API request 21 to produce abstracted API request 21AV as the following, fully textual representation vector: [slash str slash str slash str slash numeric str emma str cmma str minus str str stun numeric str].

Additionally, or alternatively, API preprocessing module 160 may be configured to identify specific fields of API request 21, and maintain (e.g., refrain from abstracting) the values of these fields. For example, a Uniform Resource Locator (URL) of an HTTP API request 21 may include one or more combinations of key+value entries. API preprocessing module 160 may be configured to maintain the key in its original form, and only abstract the value entry. In this example, API preprocessing module 160 may convert a key+value entry such as “Name=Abraham” to the following, partially abstracted, fully textual entries [name equal str], and include these entries in abstracted API request 21AV.

According to some embodiments, one or more (e.g., each) API request 21/21AV (e.g., baseline API requests 21/21AV, target API requests 21/21AV) may include, or may be associated with endpoint information 21EI. The term endpoint information may refer herein to any type of data or metadata that may represent a type, an origin or identification of a respective API request 21/21AV.

For example, endpoint information 21EI may include: (a) a method of the API request 21, (b) a hostname associated with, or accommodating API request 21, and (c) a path included in API request 21.

Pertaining to the example of FIG. 4, endpoint information 21EI may include, or may be defined by (a) the method or type of API request 21 (e.g., “GET”), (b) the hostname of API request 21 (e.g., “http://127.0.0.1:5000”), and (c) the path of API request 21 (e.g., “/orders/get/id/9013”).

Additionally, or alternatively, endpoint information 21EI may be configured to include any additional information which may uniquely identify a type of API request 21.

As elaborated herein, endpoint information 21EI may represent a unique type of an API request in a sense that system 10 may evaluate anomaly of incoming API requests 21 in relation to their specific types, as manifested by unique combinations of endpoint information values 21EI.

In other words, and as elaborated herein, during the training stage, system 10 may train model 133 (and/or model 134) to represent API requests 21 as API vectors 133B in the textual embedding space for all types of API requests 21, e.g., for all endpoint information 21EI combinations. In a subsequent inference stage, system 10 may compare API vectors 133B of incoming API requests 21 in relation to API vectors 133B of the same API request 21 type (e.g., having the same combination of endpoint information 21EI), to evaluate normality or anomaly of the incoming API request 21.

According to some embodiments, system 10 may include one or more API endpoint analysis modules 110 (or endpoint modules 110, for short). API preprocessing module 160 may direct, or transmit one or more (e.g., each) API request 21/21AV to a respective, dedicated endpoint module 110, based on the endpoint information 21EI associated with, that API request 21/21AV. For example, API preprocessing module 160 may direct a first API request 21/21AV, characterized by a first combination of endpoint information 21EI values (e.g., representing a first combination of API method, hostname and path) to a first, dedicated endpoint module 110, and direct a second API request 21/21AV, characterized by a second combination of endpoint information 21EI values (e.g., representing a second combination of API method, hostname and path) to a second, dedicated endpoint module 110.

According to some embodiments, at least one endpoint module 110 may include an API behavioural model 112, configured to calculate, for one or more baseline API requests 21B/21AV one or more corresponding behavioural statistic metrics or values 112S. Behavioural statistic values 112S may represent a statistic metric of usage of API requests 21 (e.g., baseline API requests 21) associated with identical or similar endpoint information 21EI.

For example, behavioural statistic values 112S may include a value of frequency of performing a server query by a specific type of API requests 21 (e.g., API requests having the same combination of endpoint information 21EI values).

In another example, behavioural statistic values 112S may include a value of frequency of performing server queries by a specific user, or group of users (e.g., users pertaining to a specific Internet domain). Other behavioural statistic metrics 112S may also be used.

As elaborated herein, during an inference stage, system 10 may receive a target API request of interest 21T. Endpoint module 110 may then employ API behavioural model 112 to obtain behavioural statistic values 112S that correspond to baseline API requests 21/21AV of similar type (e.g., similar combination of endpoint information 21EI). Endpoint module 110 may also attribute a specific identifier 112A of the analyzed target API requests 21T/21AV, and transmit target API requests 21T/21AV adjoint with behavioural statistic values 112S and/or identifier 112A to an API request anomaly detection module 130 (or “anomaly module 130”, for short).

Anomaly module 130 may be implemented by one or more computing devices such as computing device 1 of FIG. 1. For example, anomaly module 130 may be implemented by a plurality of cloud-based, communicatively connected, distributed computing servers.

As elaborated herein, anomaly module 130 may be configured to identify or determine an anomaly in target API request 21T/21AV based on (i) content of API request 21T/21AV, (ii) the one or more behavioural statistic values 112S and/or (iii) the endpoint information 21EI of the target API request 21T/21AV.

As shown in FIG. 3, anomaly module 130 may include a machine-learning (ML)-based language model 133, which may be trained, as elaborated herein to produce an embedding, or representation of textual data in a textual embedding space.

According to some embodiments, during a training stage, anomaly module 130 may receive a training dataset, that may include a plurality of verified, legitimate (e.g., devoid of anomalous) baseline API requests 21B, each associated with a corresponding type, or endpoint information 21EI. Anomaly module 130 may produce, for one or more (e.g., each) baseline API requests 21B of the dataset, a respective, fully textual, abstracted version 21AV.

Anomaly module 130 may apply an unsupervised training algorithm, to train ML-based language model 133, to produce the baseline API vectors 133B based on: (a) the fully textual, abstracted versions 21AV of the baseline API requests 21B, and (b) the endpoint information 21EI (e.g., the type) of the baseline API requests.

In some embodiments, language model 133 may produce the textual embedding space so as to represent a reduced dimensionality of text in relation to the fully textual, abstracted version 21AV of baseline API requests 21 of the dataset. Additionally, or alternatively, baseline API vectors 133B may include a substantially reproducible version of the at least one respective baseline API requests 21B, in the textual embedding space.

According to some embodiments, during an inference stage, ML based language model 133 may receive (e.g., from at least one client computing device 20), a target API request 21T (e.g., in a fully textual, abstracted format 21AV). Anomaly module 130 may infer language model 133 on target API request 21T/21AV, to generate a target API vector 133T that represents an embedding of a text of the target API request 21T/21AV in the textual embedding space.

According to some embodiments, each entry of API vector 133T may correspond to a specific textual feature, represented as a specific dimension in the textual embedding space.

Language model 133 may include, or may be implemented by any type of ML-based model architecture that may enable or facilitate extraction of numerical features from text, as known in the art of Natural Language Processing (NLP). For example language model 133 may include an instantiation of the currently available Bidirectional Encoder Representations from Transformers (BERT) model, FastText model, Word2Vec model, and/or any other appropriate ML-based model for language embedding. As known in the art, such model architectures (e.g., BERT, FastText, Word2Vec, and the like) may facilitate efficient learning of representations of words and sentences as numerical vectors (e.g., 133B, 133T) via unsupervised training.

Additionally, or alternatively, language model 133 may include a tokenization module 131, and a corresponding token-based language model 133. For example, language model 133 may include an instantiation of the currently available ROBERTa model. As known in the art, the ROBERTa model 133 may facilitate efficient learning of representations of sub-word portions of text, denoted herein as ‘tokens’ (e.g., letters and syllables, etc.) as numerical vectors (e.g., 133B, 133T) via unsupervised training.

Representations 133B/133T may therefore be viewed as an embedding layer, which manifests patterns in textual representation 21AV of incoming API requests 21. System 10 may subsequently analyze representations 133B/133T to determine, or identify anomalies in text of the target API request 21.

As shown in FIG. 3, anomaly module 130 may include a nearest neighbor, or Approximate Nearest Neighbour (ANN) model 134. As known in the art, an ANN model may include a plurality of points in a multidimensional space. Each such point may represent features of a respective data example in the multidimensional space. An ANN model may be utilized to facilitate a proximity search, such as a Nearest Neighbour Search (NNS), as commonly referred to in the art. During a proximity search, points in the ANN model that are closest to a given target, or query point of interest may be identified.

Closeness among points in the ANN model may represent similarity among features of the underlying data examples. This closeness may be expressed by a distance function value, which may represent dissimilarity among the features of respective data examples. Therefore, ANN model 134 may utilize a proximity search to identify one or more baseline data examples, that are characterized by features represented in the multidimensional space, that are most similar to those of a queried data example.

During the training stage, anomaly module 130 may receive, e.g., via language model 133 a plurality of baseline API vectors 133B. One or more (e.g., each) API vectors 133B may be, or may represent an embedding of text of a respective baseline API request 21B (e.g., abstracted format 21AV) in the textual embedding space. For example, each entry of API vectors 133T/133B may correspond to a specific textual feature, represented as a specific dimension in the textual embedding space.

Anomaly module 130 may then obtain, or calculate ANN model 134 based on the API vectors 133T/133B of the textual embedding space.

According to some embodiments, dimensions of ANN model 134 may correspond to the dimensions of the textual embedding space. In other words, each API vector 133T/133B may be represented as a point in the multidimensional space of ANN model 134.

Additionally, or alternatively, and as elaborated further herein, dimensions of ANN model 134 may correspond to indexed representations of API vectors 133T/133B of the textual embedding space.

ANN model 134 may therefore support a proximity search (e.g., nearest neighbour search) among a plurality of baseline API vectors 133B, to identify baseline API requests 21B that are most similar to a queried, target API request 21T.

During an inference stage, anomaly module 130 may obtain, from language model 133, a target API vector, corresponding to an incoming target API request 21T. Anomaly module 130 may perform a search (e.g., an NNS) of the nearest neighbour model ANN 134 based on the target API vector 133T, to select one or more baseline API vectors 133B according to a predefined distance metric value 134D.

Additionally, or alternatively, nearest neighbour model ANN 134 may include a separate representation for each endpoint. For example, for each combination of endpoint information 21EI (e.g., a method of the API request 21, a hostname associated with API request 21 and a path included in API request 21), ANN 134 may have a specific, unique labelling. In such embodiments, anomaly module 130 may confine the proximity search of the nearest neighbour model ANN 134 (according to distance metric 134D) to baseline API vectors 133B that pertain to the same endpoint (e.g., have the same combination of endpoint information 21EI as target API vector 133T.

For example, anomaly module 130 may select the one or more baseline API vectors 133B by (a) calculating one or more respective distance metric values 134D (e.g., cosine distance values), each representing a distance of the target API vector to a specific baseline API vector in the textual embedding space of ANN 134, and (b) selecting the one or more baseline API vectors based on the one or more calculated distance metric values 134D (e.g., having the least cosine distance values).

According to some embodiments, anomaly module 130 may include an anomaly analysis module 138, configured to calculate a similarity metric value 138S, representing similarity of the target API request 21T to the one or more baseline API requests 21B, based on the target API vector 133T and the selected one or more baseline API vectors 133B. For example, similarity metric value 138S may be a function (e.g., a maximum value, an average value, a weighted sum value, etc.) of the distance metric values 134D of the selected one or more baseline API vectors 133B.

Anomaly module 130 may subsequently determine, or notify 138N an anomaly of the target API request 21T based on the similarity metric value 138S. For example, anomaly module 130 may produce a notification 138N of target API request 21T being anomalous when similarity metric value 138S surpasses a predetermined threshold value.

In other words, anomaly module 130 may determine that target API request 21T is anomalous, and produce a notification 138N thereof, when target API request 21T is dissimilar from baseline API request 21B of the selected (e.g., most similar) baseline API vectors 133B in the language embedding space as represented by ANN 134.

Additionally, or alternatively, anomaly module 130 may determine that target API request 21T is anomalous further based on (i) the one or more behavioural statistic values 112S and (ii) the endpoint information 21EI of the target API request 21T/21AV.

In other words, anomaly module 130 may determine that target API request 21T is anomalous, and produce a notification 138N thereof, when (i) target API request 21T is dissimilar from baseline API request 21B of the selected (e.g., most similar) baseline API vectors 133B in the language embedding space as represented by ANN 134, and/or (ii) the behavioural statistic values 112S of target API request 21T is different, beyond a predefined threshold, from behavioural statistic values 112S of baseline API requests 21B that pertain to the same endpoint (e.g., have the same combination of endpoint information 21EI, as represented by identifier 112A).

As known in the art, currently available methods of API anomaly detection may rely on ML-based classification for categorizing incoming API traffic as benign or anomalous. As explained herein, this approach is typically too slow to infer on large traffic volume. For example, the current classification approach is typically (a) unscalable, in a sense that a new classification model must be trained for each newly introduced API request 21 type or endpoint 21EI, and (b) lacks robustness, due to inadequate training or existence of outliers.

By using an approximate nearest neighbour proximity search, embodiments of the invention represents a shift in paradigm for categorizing incoming API requests. In other words, embodiments of the invention may turn the problem of API traffic categorization from a classification problem, characterized by the abovementioned limitations of scalability and robustness to that of a proximity search (e.g., an approximate nearest neighbour search) problem, which may be immune to such limitations. Moreover, embodiments of the invention may employ intelligent indexing of the API vectors 133 to boost the yield of the proximity search algorithm, thus providing further improvement over currently available, classification based approaches.

According to some embodiments, system 10 may adapt the proximity search (e.g., NNS) algorithm to the underlying task (e.g., the task of searching for similarity among embeddings of textually represented API requests). As elaborated herein, such adaptation may include adoption of an indexed search algorithm. It has been experimentally demonstrated that such indexed search may boost throughput, and decrease latency of API anomaly detection by embodiments of the invention, in relation to comparable, currently available API security methods.

According to some embodiments, during a training stage, anomaly detection module 130 may receiving a plurality of baseline API requests 21B/21AV, and infer the ML based language model 133 on the plurality of baseline API requests 21B/21AV, to produce a respective plurality of baseline API vectors 133B. According to some embodiments, ANN model 134 may include, or may be associated with an indexing module 134IND. Indexing module 134IND may be configured to calculate, for one or more (e.g., each) baseline API vectors 133B, a respective API index 134B.

For example, indexing module 134IND may calculate, for one or more first baseline API vectors 133B one or more respective baseline indices 134B, each representing neighborhood relationships of the one or more first baseline API vectors 133B with one or more second baseline API vectors 133B in the textual embedding space of the ANN model 134.

For example, indexing module 134IND may be, or may include a Hierarchical Navigable Small World Graph (HNSW) module, configured to produce HNSW indices 134B. As known in the art, HNSW is a graph-based indexing algorithm that incrementally builds a multi-layer structure consisting of a hierarchical set of proximity graphs, or layers, for nested subsets of the stored elements. Upper HNSW layers may be selected randomly, with an exponentially decaying probability distribution, from the lower layers.

HNSW indices may represent neighborhood relationships (e.g., proximity) among input elements (e.g., in this case-proximity among API vectors 133B/133T, in the textual embedding space). For example, indices 134B having a similar value (e.g., having a first, small difference between them) may represent API vectors 133B/133T that are in close proximity in the textual embedding space, whereas indices 134B having a dissimilar value (e.g., having a second, larger difference between them) may represent API vectors 133B/133T that are positioned further apart in the textual embedding space.

HNSW may thus facilitate a quick proximity search among the stored elements (e.g., among API vectors 133B/133T). In such embodiments, ANN model 134 may start a search from an uppermost layer of the HNSW indexing module 134IND, to find a node (e.g., representing a baseline API vector 133B) that is closest to a target node (e.g., representing a target API vector 133T), in that layer. ANN model 134 may subsequently proceed down to the next layer, to begin another search, thereby refining the proximity search (e.g., finding proximate baseline API vectors 133B, in an ever increasing resolution). After a predefined number of iterations, ANN model 134 may approach, or identify one or more baseline API vectors 133B as closest (e.g., most similar) to target API vector 133T in the textual embedding space.

As elaborated herein, one or more (e.g., each) API request 21 (e.g., baseline API request 21B) may include, or may be associated with endpoint information 21EI, such as a method of the API request 21, a hostname associated with API request 21 and a path included in the API request 21. API request 21 (e.g., baseline API request 21B) may be directed by API preprocessing module 160, to be handled by a dedicated API endpoint module 110 based on the associated endpoint information 21EI. For example, each combination of endpoint information 21EI values (e.g., method, hostname and path) may be directed to, and handled by a unique, dedicated API endpoint module 110.

According to some embodiments, an endpoint module 110 relevant to a specific API requests 21 may attribute, or associate a specific identifier 112A to that API request 21 (e.g., 21T/21B/21AV). Identifier 112A may, for example, represent an identity of the specific endpoint module 110. In other words, since each endpoint module 110 corresponds to a specific combination or content of endpoint information 21EI, identifier 112A may identify, or tag the baseline API requests 21B/21AV according to that combination or content of endpoint information 21EI.

Endpoint module 110 may subsequently transmit API requests 21B/21AV adjoint with the attributed identifier 112A to anomaly module 130. Indexing module 134IND may then calculate, for one or more (e.g., each) API vectors (e.g., baseline API vectors 133B), a respective API index 134B further based on the endpoint information 21EI.

For example, indexing module 134IND may calculate API index 134B as a compressed representation or compressed version, or a representation of (i) the endpoint information 21EI of the respective baseline API request (e.g., as represented by content of the attributed identifier 112A), and (ii) content of the baseline API vector 133B of the respective baseline API request 21B.

In other words, an API index 134B of a specific API request 21 may be utilized to uniquely identify (i) an endpoint (e.g., method, hostname and path) included in API request 21, and (ii) a position of the respective API vector 133B in the language embedding space, as represented by ANN 134.

According to some embodiments, during an inference stage, anomaly module 130 may receive a query to determine legitimacy of an incoming target API request 21T/21AV. Anomaly module 130 may apply language model 133 on API request 21T/21AV, to obtain a corresponding target API vector 133T, as elaborated herein.

Anomaly module 130 may use baseline API indices 134B to perform an indexed search through ANN model 134. Anomaly module 130 may thereby select one or more baseline API vectors 133B that are characterized by having minimal distances from target API vector 133T in the textual embedding space of ANN 134. Additionally, or alternatively, the selected baseline API vectors 133B may be characterized by having the same endpoint information (e.g., method, hostname and path) included in the target API request 21.

It may be appreciated that ANN model 134 may evolve, or be retrained continuously (e.g., repeatedly, over time) as additional API request 21 are received. Therefore, after approving target API request 21T as a normal (e.g., not anomalous) API request, indexing module 134IND may calculate a target API index 134T in a similar manner to that of baseline API indices 134B, as elaborated herein. In other words, target API index 134T may represent endpoint information 21EI of the respective target API request 21T, and content of the target API vector 133T. In subsequent searches, relating to subsequent, incoming target API requests 21T, target API index 134T may be treated as a new baseline API index 134B, and may be retrieved by anomaly module 130 as similar to the new, incoming target API request 21T.

According to some embodiments, ANN 134 may be implemented as a finite database of objects, each relating to an API index 134T/134B of a respective API request 21. Anomaly module 130 may perform a search query relating to a target API request 21T of interest, and designate a dissimilarity metric or distance metric 134D of choice (e.g., a cosine distance).

In response to that query, ANN 134 may retrieve a subset of database objects (e.g., baseline API requests 21B and/or corresponding baseline indices 134B), and corresponding distance metric values 134D that are sufficiently similar (e.g., having minimal distance metric values 134D) to the queried target API request 21T.

Additionally, or alternatively, anomaly module 130 may perform the search query through incremental steps (e.g., repeatedly over time), where in each step an index 134B of a baseline vector 133B that is most similar (e.g., closest) to the target vector 133T is selected, until a predetermined number of baseline indices 134B and their corresponding distance metric values 134D are obtained.

As elaborated herein, anomaly module 130 may then select one or more baseline vectors 133B, as most similar to target vector 133T, based on the indexed search, and may calculate similarity metric value 138S based on the selected one or more baseline vectors 133B. Anomaly module 130 may subsequently produce notification 138N, indicating possible anomaly of API request 21T, based on the selected one or more baseline vectors 133B (e.g., when similarity metric value 138S exceeds a predefined, or calculated value).

For example, anomaly module 130 may be configured search for an integer (K) number of points in a given set of baseline API requests 21B that are closest to a given target API request 21T, and may use API vectors 133 to build the search space using a distance metric such as cosine distance metric, yielding a sorted vector X̅ of K distance metric values, as in the example of Table 1, below:

Distance metric values

0.23029733
0.23348331
0.23411936
0.23428679
0.23764753
0.23923737
0.23981643

Anomaly module 130 may then apply a normalization function on the sorted vector of K distance metric values, based on its maximal value, e.g., according to the normalization function example of Eq. 1, below:

$${X}^{′} = 1 ( X - max ( \overline{X} ) ) \qquad Eq . 1$$

where X represents a distance metric value 134D included in sorted vector X̅ of K distance metric values 134D, and X′ represents a normalized value of the respective distance metric value X.

Pertaining to the example of table 1, application of the normalization function will yield the normalized vector of distance metric values 134D as in Table 2, below:

TABLE 2
Normalized Distance metric values

0.0396933
0.0264082
0.02375597
0.02305782
0.00904399
0.00241458
0

In such embodiments, a similarity metric value 138S may include a maximal value of the normalized vector of distance metric values 134D. In this example, this value is 0.0396933. Additionally, or alternatively, similarity metric value 138S may be calculated as an average of normalized distance metric values 134D. In this example, this value is 0.017767694. Additional appropriate functions of calculating similarity metric value 138S based on distance metric values 134D are also possible.

As elaborated herein, anomaly module 130 may then determine anomaly of the target API request 21T based on the similarity metric value 138S, e.g., when similarity metric value 138S exceeds a predetermined threshold value.

As shown in FIG. 3, anomaly module 130 may include an attack mitigation module 139 (or “mitigation module 139” for short), adapted to mitigate effect of a suspected cyber-attack based on anomaly indication 138N.

As shown in FIG. 2, system 10 may be communicatively connected (e.g., via Internet) to at least one computing 30, such as an application back-end server or storage server, to which API requests 21 may be directed. Mitigation module 139 may be configured to transmit API request 21 (here denoted 21′) to server 30, or block (e.g., refrain from transmitting) API request 21, based on said determination of anomaly (e.g., when indication 138N represents anomaly, or maliciousness) of API requests 21.

For example, mitigation module 139 may be configured to restrict at least one client computing device 20, from which a target API request 21T (e.g., an API request that involves access to a server 30) has originated, from accessing at least one server 30 such as an application server 30, or a storage server 30, based on said determination of anomaly.

In another example, mitigation module 139 may transmit, or pass 21T′ a first target API request 21T, corresponding to a first combination or value of endpoint information 21EI to server 30, and may prevent, or block a second target API request 21T, corresponding to a second combination or value of endpoint information 21EI from reaching server 30.

In another example, mitigation module 139 may “white-list” or “black-list” specific elements, or combination of elements of endpoint information 21EI (e.g., specific user identifications, specific client device identifications, specific application (e.g., browser) identifications, etc.) in accessing server computing device 30. Additional examples of such mitigation actions may also be possible.

In yet another example, mitigation module 139 may transmit anomaly indication 138N as a message (e.g., a Short Message Service (SMS) message, an email, and the like) to at least one predefined destination or account (e.g., phone number, email account) of a predetermined stakeholder (e.g., Information Technology (IT) specialist), to enable that person to act upon the suspected anomaly.

As elaborated herein, and shown in FIG. 2, API request 21 (e.g., the target API request 21T) may include a request to access server computing device 30. System 10 may transmit the target API request to the server computing device 30, and receive, from the server computing device 30 an API response 21R corresponding to, or in response to, the target API request 21T.

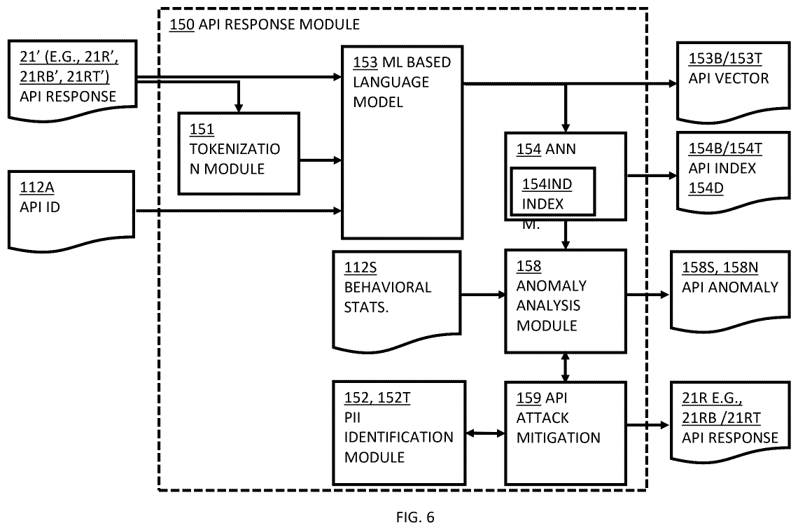

Reference is further made to FIG. 6, which is a block diagram, depicting an API response module 150, which may be included in a system 10 for API anomaly detection, according to some embodiments of the invention.

According to some embodiments, API response module 150 may be configured to identify anomalies in API responses (denoted herein with the notation ‘R’, such as 21R′), received from server 30, in a similar manner to the identification of anomalies in API requests 21 by API anomaly module 130.

For example, API response module 150 may include similar modules as those of API anomaly module 130 elaborated herein, with corresponding, respective enumerations (e.g., elements 151, 153, 153B, 153T, 154, 154IND, 154B, 154T, 158, 158S, 158N and 159 of API response module 150 corresponding to elements 131, 133, 133B, 133T, 134, 134IND, 134B, 134T, 138, 138S, 138N and 139 of API anomaly module 130, respectively).

Description of modules and functions of API response module 150 will therefore not be fully repeated here, for sake of brevity. It may suffice to say that API response module 150 may follow similar operations of API anomaly module 130.

For example, API response module 150 may receive a target API response 21RT′ from at least one server computing device, and may infer an ML based language model 153 on the target API response 21RT′, to generate a target API vector 153, representing an embedding of a text of the target API response 21RT′ in a textual embedding space. API response module 150 may obtain, or train a nearest neighbor model ANN 154, that may include a plurality of baseline API response vectors 153B, each representing embedding of text of a respective baseline API response 21RB′ in the textual embedding space. System 10 may employ nearest neighbor model ANN 154 to perform a search (e.g., an indexed, approximate nearest neighbour search, as elaborated herein) to search through the nearest neighbor model ANN 154, based on the target API vector, and select one or more baseline API response vectors 153B.

Anomaly analysis module 158 may then calculate a similarity metric value 158S, representing similarity of the target API response 21RT′ to the one or more baseline API responses 21RB′, based on the target API response vector 153T and the selected one or more baseline API response vectors 153B. Anomaly analysis module 158 may subsequently proceed to determining anomaly of the target API response 21RT′, based on the similarity metric value 158S, and may collaborate with API mitigation module 159 to transmit, or block target API response 21RT′ from reaching client module 20 (denoted response 21R in FIG. 2).

As known in the art, Personal Identification Information (PII) includes any type of data that can be used to identify a person, including for example their name, name, address, phone number, and the like.

According to some embodiments, API response module 150 may include a PII identification module 152, configured to analyze a specific API response 21R′ to identify at least one PII token 152T therein. In other words, PII token 152T may indicate whether the specific API responses 21R′ includes a specific type (e.g., name) of PII information.

PII identification module 152 may collaborate with attack mitigation module 159, to ascertain whether API response 21R′ should be transmitted to at least one client computing device 20 (e.g., in response to API request 21), based on said identified token of personal information.

For example, API vectors 153B/153T of ML model 153 may include abstracted representation for specific PII information (e.g., in addition the information presented in FIG. 5) in a textual embedding space, as elaborated herein (e.g., in relation to ML model 133). ANN model 154 may consequently include indexed representations 154B/154T of API vectors 153B/153T. System 10 may this utilize ANN 154 to identify anomalous retrieval of PII information from server 30:

As elaborated herein, system 10 may perform an indexed, approximate nearest neighbour search of ANN 154, based on the target API vector 153T, to select one or more baseline API response vectors 153B that are most similar to target API vector 153T. When API response vectors 153B of the most similar API responses 21R′ do not include PII information, whereas target API response of target API vector 153T does include such PII information, mitigation module 159 may choose to block target API response 21RT′ from reaching client 20. Additionally, or alternatively, mitigation module 159 may alert that anomalous PII data has been unexpectedly received from server 30.

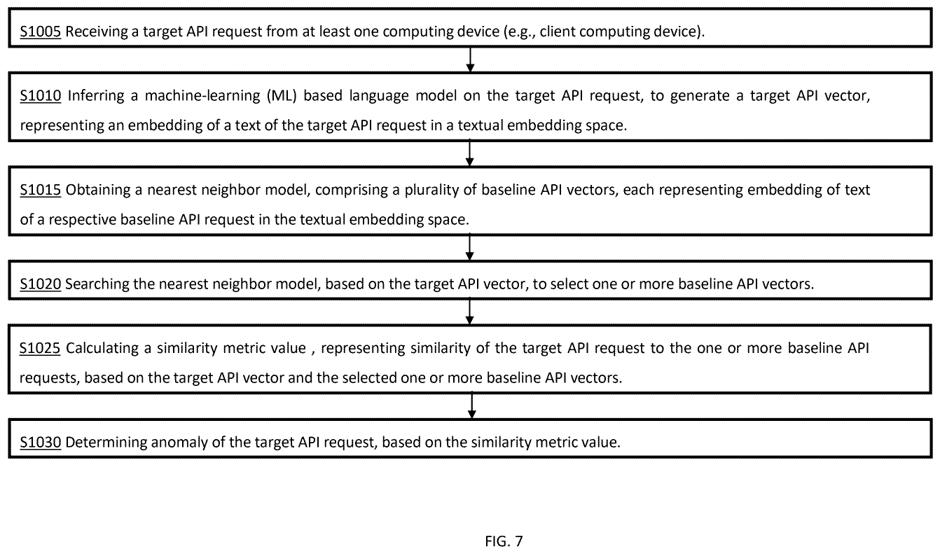

Reference is now made to FIG. 7, which is a flow diagram, depicting a method of API anomaly detection by at least one processor (e.g., processor 2 of FIG. 1), according to some embodiments of the invention.

As shown in steps S1005 and S1010, the at least one processor 2 may receive an API request 21 (e.g., a target API request 21T of FIG. 2) from at least one computing device (e.g., client computing device of FIG. 2). The at least one processor 2 may infer, or apply a statistical model, such as an ML-based, language model 133 of FIG. 3 on the target API request 21T, to generate a target API vector (e.g., API vector 133T of FIG. 3). As elaborated herein, API vector 133T may represent an embedding of text, that is included in target API request 21T, in a textual embedding space. Additionally, or alternatively, API vector 133T may represent an embedding of text that is included in a fully textual, abstracted version 21AV of the target API request 21T in the textual embedding space.

As shown in step S1015, the at least one processor 2 may obtain a nearest neighbor model (e.g., ANN 134 of FIG. 3), that may include a plurality of baseline API vectors, each representing embedding of text of a respective baseline API request 21B in the textual embedding space.

As shown in step S1020, the at least one processor 2 may search the nearest neighbor model ANN 134, based on the target API vector 21T, to select one or more baseline API vectors 21B (e.g., having minimal distance metric values 134D from target API vector 21T in the textual embedding space).

As elaborated herein (e.g., in relation to Table 1 and Table 2), and as shown in steps S1025 and S1030, the at least one processor 2 may calculate a similarity metric value 138S, representing similarity of the target API request 21T to the one or more baseline API requests 21B, based on the target API vector 21T and the selected one or more baseline API vectors 21B. The at least one processor 2 may subsequently determine anomaly of the target API request, based on the similarity metric value 138S.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of Application Programming Interface (API) anomaly detection by at least one processor, the method comprising:
receiving a target API request from at least one client computing device;
inferring a machine-learning (ML) based language model on the target API request, to generate a target API vector, representing an embedding of a text of the target API request in a textual embedding space;
obtaining a nearest neighbor model, comprising a plurality of baseline API vectors, each representing embedding of text of a respective baseline API request in the textual embedding space;
searching the nearest neighbor model, based on the target API vector, to select one or more baseline API vectors;
calculating a similarity metric value, representing similarity of the target API request to the one or more baseline API requests, based on the target API vector and the selected one or more baseline API vectors; and
determining anomaly of the target API request, based on the similarity metric value.

2. The method of claim 1, further comprising:
calculating one or more distance metric values, each representing a distance of the target API vector to a specific baseline API vector in the textual embedding space; and
selecting the one or more baseline API vectors based on the one or more calculated distance metric values.

3. The method of claim 1, wherein obtaining the nearest neighbor model comprises:
receiving a plurality of baseline API requests;
inferring the ML based language model on the plurality of baseline API requests, to produce a respective plurality of baseline API vectors; and
for one or more first baseline API vectors of the plurality of baseline API vectors, calculating respective baseline indices, each representing neighborhood relationships of a first baseline API vector with one or more second baseline API vectors, in the textual embedding space.

4. The method of claim 3, wherein each baseline API request is associated with endpoint information representing a type of the baseline API request, and wherein each baseline index comprises a representation of (i) the endpoint information of the respective baseline API request, and (ii) the baseline API vector of the respective baseline API request.

5. The method of claim 3, wherein the target API request is associated with endpoint information representing a type of the target API request, and wherein searching the nearest neighbor model comprises using the baseline indices to perform an indexed search through the nearest neighbor model, thereby selecting one or more baseline API vectors,
wherein said selected baseline API vectors are characterized by: (i) having minimal distance from the target API vector in the textual embedding space, and (ii) having the same endpoint information as the target API request.

6. The method of claim 5, wherein the endpoint information is selected from a list consisting of a method of the API request, a hostname associated with the API request, and a path included in the API request.

7. The method of claim 1, further comprising:
receiving a dataset comprising a plurality of baseline API requests, each associated with corresponding endpoint information;
for one or more baseline API requests of the dataset, producing a respective, abstracted version; and
applying an unsupervised training algorithm on the ML-based language model to produce the baseline API vectors based on: (a) the abstracted version of the baseline API requests, and (b) the endpoint information of the baseline API requests.

8. The method of claim 7, wherein the textual embedding space represents a reduced dimensionality of text in relation to the abstracted version of the baseline API requests of the dataset, and wherein the baseline API vectors comprise a substantially reproducible version of the at least one respective baseline API requests, in the textual embedding space.

9. The method of claim 4, further comprising:
for one or more baseline API requests, calculating one or more corresponding behavioural statistic values, representing a statistic metric of usage baseline API requests associated with identical or similar endpoint information;
determining anomaly of the target API request further based on (i) the one or more behavioural statistic values and (ii) the endpoint information of the target API request.

10. The method of claim 1, further comprising restricting the at least one client computing device from accessing at least one application server computing device or storage server computing device, based on said determination of anomaly.

11. The method of claim 1, wherein the target API request comprises a request to access a server computing device, and wherein the method further comprises:
transmitting the target API request to the server computing device;
receiving, from said server computing device an API response corresponding to said target API request; and
transmitting the API response to the at least one client computing device based on said determination of anomaly.

12. The method of claim 11, further comprising:
analyzing the API response to identifying at least one token of personal information therein; and
transmitting the API response to the at least one client computing device further based on said identified token of personal information.

13. A system for API anomaly detection, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive a target API request from at least one client computing device;
infer a machine-learning (ML) based language model on the target API request, to generate a target API vector, representing an embedding of a text of the target API request in a textual embedding space;
obtain a nearest neighbor model, comprising a plurality of baseline API vectors, each representing embedding of text of a respective baseline API request in the textual embedding space;
search the nearest neighbor model, based on the target API vector, to select one or more baseline API vectors;
calculate a similarity metric value, representing similarity of the target API request to the one or more baseline API requests, based on the target API vector and the selected one or more baseline API vectors; and
determine anomaly of the target API request, based on the similarity metric value.

14. The system of claim 13, wherein the at least one processor is further configured to:
calculate one or more distance metric values, each representing a distance of the target API vector to a specific baseline API vector in the textual embedding space; and
select the one or more baseline API vectors based on the one or more calculated distance metric values.

15. The system of claim 13, wherein the at least one processor is further configured to obtain the nearest neighbor model by:
receiving a plurality of baseline API requests;
inferring the ML based language model on the plurality of baseline API requests, to produce a respective plurality of baseline API vectors; and
for one or more first baseline API vectors of the plurality of baseline API vectors, calculating respective baseline indices, each representing neighborhood relationships of a first baseline API vector with one or more second baseline API vectors, in the textual embedding space.

16. The system of claim 15, wherein each baseline API request is associated with endpoint information representing a type of the baseline API request, and wherein each baseline index comprises a representation of (i) the endpoint information of the respective baseline API request, and (ii) the baseline API vector of the respective baseline API request.

17. The system of claim 15, wherein the target API request is associated with endpoint information representing a type of the target API request, and wherein the at least one processor is further configured to search the nearest neighbor model by using the baseline indices to perform an indexed search through the nearest neighbor model, thereby selecting one or more baseline API vectors, wherein said selected baseline API vectors are characterized by: (i) having minimal distance from the target API vector in the textual embedding space, and (ii) having the same endpoint information as the target API request.

18. The system of claim 17, wherein the endpoint information is selected from a list consisting of a method of the API request, a hostname associated with the API request, and a path included in the API request.

19. The system of claim 13, wherein the at least one processor is further configured to:
receive a dataset comprising a plurality of baseline API requests, each associated with corresponding endpoint information;
for one or more baseline API requests of the dataset, produce a respective, abstracted version; and
apply an unsupervised training algorithm on the ML-based language model to produce the baseline API vectors based on: (a) the abstracted version of the baseline API requests, and (b) the endpoint information of the baseline API requests.

20. The system of claim 19, wherein the textual embedding space represents a reduced dimensionality of text in relation to the abstracted version of the baseline API requests of the dataset, and wherein the baseline API vectors comprise a substantially reproducible version of the at least one respective baseline API requests, in the textual embedding space.

21.-24. (canceled)
